(19) United States
(12) Patent Application Publication
(10) Pub. No.: US 2023/0264883 A1
(43) Pub. Date: Aug. 24, 2023

(54) CUSHION MEMBER

(71) Applicant: KYOCERA Document Solutions Inc., Osaka (JP)

(72) Inventor: Shinji NEMOTO, Osaka (JP)

(73) Assignee: KYOCERA Document Solutions Inc., Osaka (JP)

(21) Appl. No.: 18/170,177

(22) Filed: Feb. 16, 2023

(30) Foreign Application Priority Data
Feb. 21, 2022 (JP) 2022-024599

(51) Int. Cl. B65D 81/05

(52) U.S. Cl. CPC B65D 81/058; B65D 2581/053

(57) ABSTRACT

A cushion member includes a tubular cushion and an inner cushion. The tubular cushion is in a tubular form having a tubular axis extending in a first direction. The tubular cushion makes contact with an article to be packed from one side in a second direction perpendicular to the first direction. The tubular cushion deforms to damp a first impact applied from the second direction. The inner cushion is disposed in the internal space of the tubular cushion. The inner cushion deforms to damp a second impact when, after the first impact, with the tubular cushion deformed, the second impact is applied from the second direction. The lateral direction of a cardboard sheet constituting the inner cushion is the second direction.

### INCORPORATION BY REFERENCE

This application is based upon and claims the benefit of priority from the corresponding Japanese Patent Application No. 2022-024599 filed on Feb. 21, 2022, the entire contents of which are hereby incorporated by reference.

### BACKGROUND

The present disclosure relates to a cushion member.

There are conventionally known cushion members that damp impacts on an article packed in a packing case. The conventional cushion members are formed from a pulp molding material by pulp molding using a mold.

### SUMMARY

According to one aspect of the present disclosure, a cushion member is formed by folding a single cardboard sheet and includes a tubular cushion and an inner cushion. The tubular cushion is in a tubular form having a tubular axis extending in a first direction. The tubular cushion is disposed adjacent to and in contact with an article to be packed from one side in a second direction perpendicular to the first direction. The tubular cushion deforms to damp a first impact applied from the second direction. The inner cushion is disposed in the internal space of the tubular cushion. The inner cushion deforms to damp a second impact when, after the first impact, with the tubular cushion deformed, the second impact is applied from the second direction. The cardboard sheet has narrow pipes formed by an inner core in a form of a corrugated plate and a pair of liners in a form of flat plates that are bonded to the inner core. The longitudinal direction of the narrow pipes of the cardboard sheet is the first direction, and the lateral direction of the narrow pipes perpendicular to the longitudinal direction is the second direction.

### BRIEF DESCRIPTION OF THE DRAWINGS

FIG. 1 is a perspective view of cushion members according to one embodiment.

FIG. 2 is a perspective view of a state where an article to be packed is protected by the cushion members according to the one embodiment.

FIG. 3 is a schematic diagram of a cardboard sheet constituting the cushion members according to the one embodiment.

FIG. 4 is a perspective view of a first cushion member according to the one embodiment.

FIG. 5 is a perspective view illustrating the internal structure of the first cushion member shown in FIG. 4.

FIG. 6 is a cross-sectional view of the first cushion member shown in FIG. 4 cut along YZ plane.

FIG. 7 is a diagram illustrating collapsing of the cardboard sheet.

FIG. 8 is a diagram illustrating buckling of the cardboard sheet.

FIG. 9 is a diagram schematically showing a state where a first impact is applied to the first cushion member according to the one embodiment.

FIG. 10 is a perspective view of the unfolded cardboard sheet for the first cushion member according to the one embodiment.

FIG. 11 is a perspective view of a second cushion member according to one embodiment.

FIG. 12 is a schematic diagram illustrating the internal structure of the second cushion member shown in FIG. 11.

FIG. 13 is a cross-sectional view of the second cushion member shown in FIG. 11 cut along YZ plane.

FIG. 14 is a cross-sectional view of the second cushion member shown in FIG. 11 cut along XY plane.

FIG. 15 is a perspective view of the unfolded cardboard sheet for the second cushion member according to the one embodiment.

### DETAILED DESCRIPTION

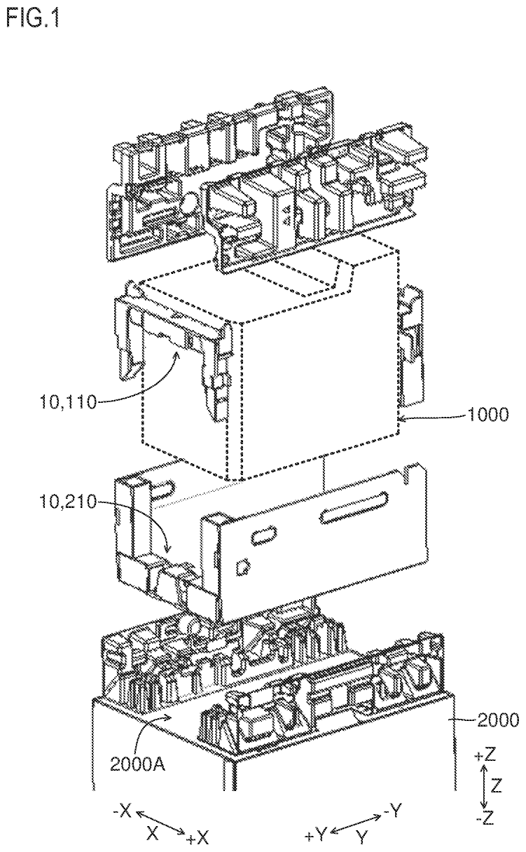

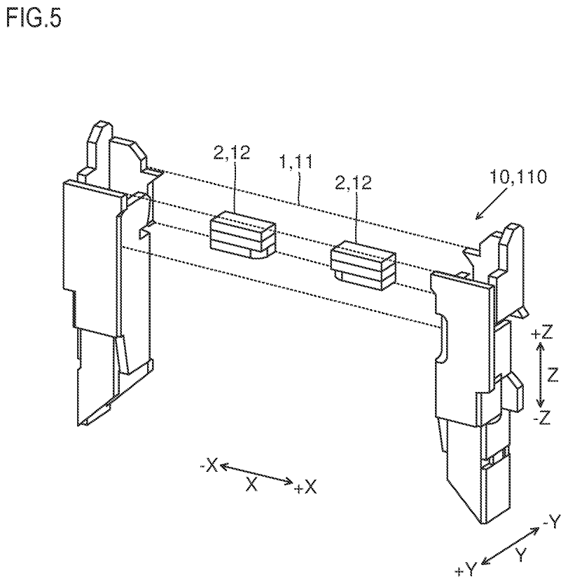

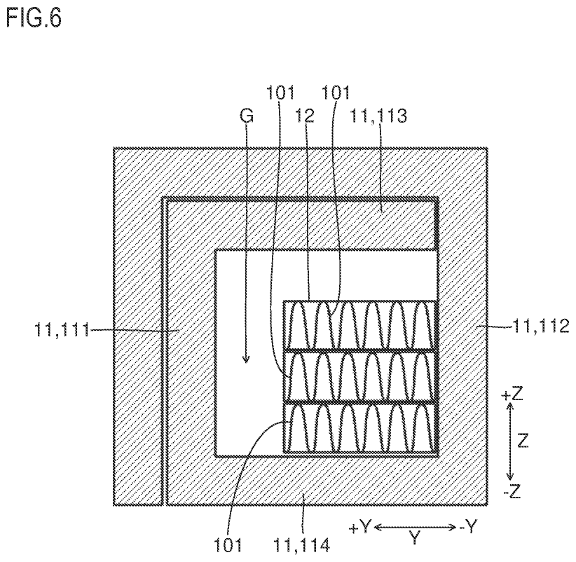

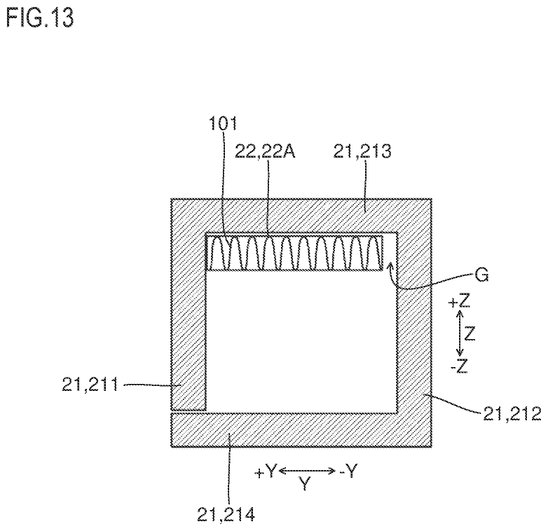

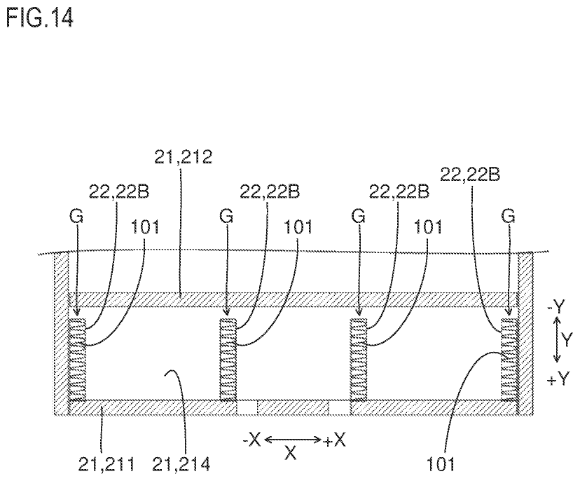

With reference to FIGS. 1 to 15, cushion members 10 according to an embodiment of the present disclosure will be described. In the following description, X direction in the diagram is defined as the left-right direction, Y direction in the diagram is defined as the front-rear direction, and Z direction in the diagram is defined as the up-down direction. The X direction corresponds to a “first direction”, the Y direction corresponds to a “second direction”, and the Z direction corresponds to a “third direction”.

Along the X direction, +X side is defined as right and —X side is defined as left. Along the Y direction, +Y side is defined as front and —Y side is defined as rear. Along the Z direction, +Z side is defined as top and —Z side is defined as bottom.

<The Overall Structure>

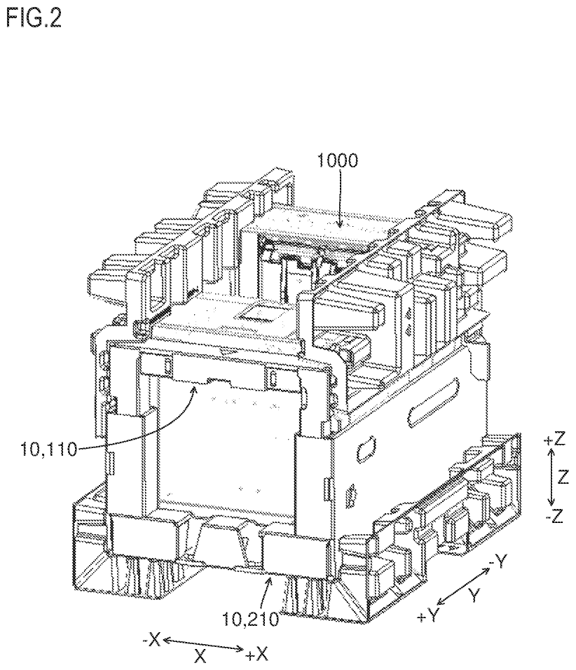

As shown in FIGS. 1 and 2, the cushion members 10 are accommodated in a packing case 2000 together with an article to be packed 1000. The cushion members 10 protect the article packed 1000 in the packing case 2000. By disposing the cushion members 10 in the packing case 2000, the impact on the article packed 1000 is damped. The article to be packed 1000 is, for example, a printer. In the packing case 2000, although not identified by any reference signs, also cushion members other than the cushion members 10 are disposed.

The packing case 2000 is formed of a cardboard sheet. The packing case 2000 has an opening 2000A at the top side. The cushion members 10 are put in or taken out of the packing case 2000 through the opening 2000A. That is, the direction in which the cushion members 10 are put in or taken out of the packing case 2000 is the up-down direction. Likewise, the article to be packed 1000 is put in or taken out of the packing case 2000 through the opening 2000A.

The cushion members 10 are disposed at the top and bottom sides. As will be described in detail later, the cushion members 10 at the top and bottom sides each include a tubular cushion 1 and an inner cushion 2. The cushion member 10 at the top side damps the impact on the top front side of the article to be packed 1000. The cushion member 10 at the bottom side damps the impact on the bottom front side of the article to be packed 1000.

In the following description, wherever the cushion members 10 at the top and bottom sides need to be distinguished, the cushion member 10 at the top side is identified by the reference sign 110 and referred to as a first cushion member 110, and the cushion member 10 at the bottom side is identified by the reference sign 210 and referred to as a second cushion member 210. The tubular cushion 1 in the first cushion member 110 is identified by the reference sign 11 and referred to as a first tubular cushion 11, and the inner cushion 2 in the first cushion member 110 is identified by the reference sign 12 and referred to as a first inner cushion 12. The tubular cushion 1 in the second cushion member 210 is identified by the reference sign 21 and referred to as a second tubular cushion 21, and the inner cushion 2 in the second cushion member 210 is identified by the reference sign 22 and referred to as a second inner cushion 22.

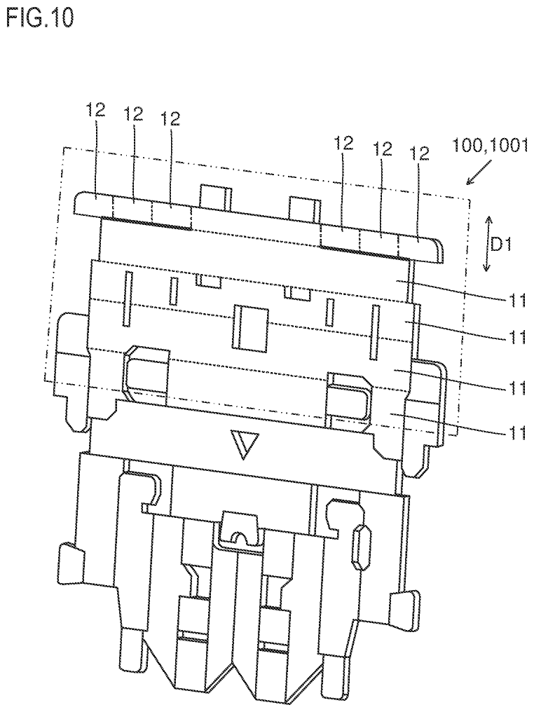

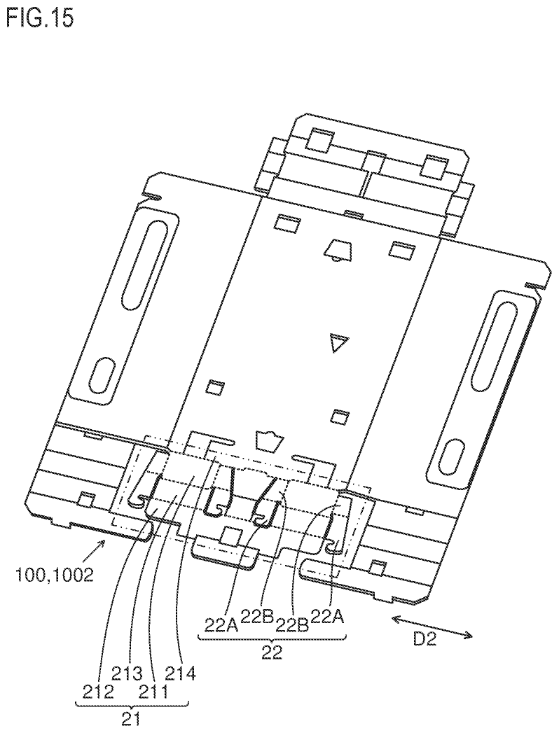

Here, the cushion member 10 is formed by folding a single cardboard sheet 100 (see FIGS. 10 and 15). In other words, the tubular cushion 1 and the inner cushion 2 are formed by folding a single cardboard sheet 100. A description will be given later of how the cushion member 10 is formed (how the cardboard sheet 100 is folded).

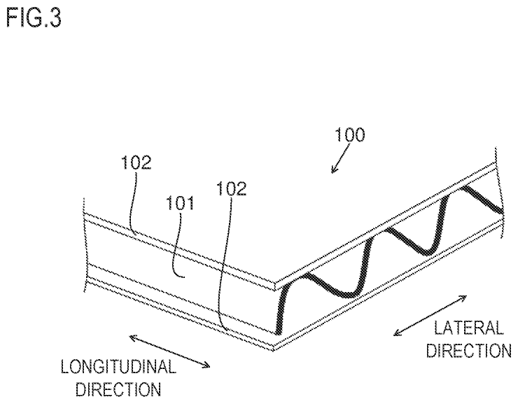

The cardboard sheet 100 used for the cushion member 10 is, as shown in FIG. 3, a sheet material having an inner core 101 and a pair of liners 102. The inner core 101 is a corrugated plate. The pair of liners 102 include an obverse liner and a reverse liner. The pair of liners 102 are each a flat plate. The inner core 101 is held between the pair of liners 102. The inner core 101 and the pair of liners 102 are bonded with each other. That is, the tubular cushion 1 and the inner cushion 2 are each formed of a sheet member made by bonding together the inner core 101 and the pair of liners 102. The cardboard sheet 100 as the sheet member has narrow pipes formed by the inner core 101 in the form of a corrugated plate and the pair of liners 102 in the form of flat plates.

In the cardboard sheet 100, the longitudinal direction is the sheet width direction of the inner core 101, and is the direction of the corrugations formed in the inner core 101. In the cardboard sheet 100, the lateral direction is the flow direction of the inner core 101, and is the direction perpendicular to the longitudinal direction. In other words, the lateral direction is the direction perpendicular to the extension direction of the narrow pipes formed by the inner core 101 and the pair of liners 102.

<Detailed Configuration of the Cushion Members>

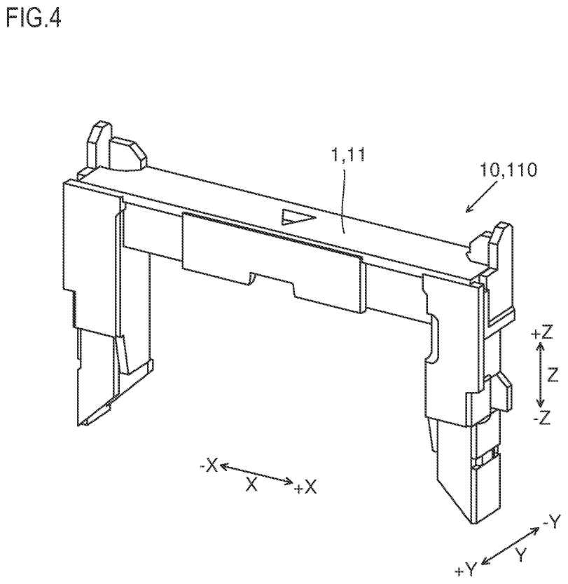

First, a description will be given of the first tubular cushion 11 and the first inner cushion 12 with reference to FIGS. 4 to 6.

The first tubular cushion 11 is in a tubular form having a tubular axis that runs along the left-right direction. The first tubular cushion 11 is folded into a hollow rectangular columnar shape. When the first cushion member 110 is accommodated in the packing case 2000 together with the article to be packed 1000, one of the four surfaces of the outer wall of the first tubular cushion 11 faces the article to be packed 1000 and makes contact with the front top side of the article to be packed 1000.

The first tubular cushion 11 has a first wall portion 111 and a second wall portion 112 that are disposed so as to face each other in the front-rear direction. The first tubular cushion 11 also has a third wall portion 113 and a fourth wall portion 114 that are disposed so as to face each other in the up-down direction.

The first wall portion 111 is disposed at the front side. The second wall portion 112 is disposed at the rear side. The second wall portion 112 faces the article to be packed 1000 in the front-rear direction and makes contact with the article to be packed 1000 from the front side. In other words, the outer surface of the second wall portion 112 makes contact with the article to be packed 1000. The third wall portion 113 is disposed at the top side and the fourth wall portion 114 is disposed at the bottom side.

The first inner cushion 12 is disposed in the internal space of the first tubular cushion 11. Specifically, the first inner cushion 12 is disposed in a space surrounded by the first, second, third, and fourth wall portions 111, 112, 113 and 114. In other words, the first tubular cushion 11 has the first inner cushion 12 in its internal space. In yet other words, the first tubular cushion 11 has the inner core 101 as a corrugated plate in its internal space.

The first inner cushion 12 is disposed such that the lateral direction of the inner core 101 of the first inner cushion 12 runs along the front-rear direction. The lateral direction of the inner core 101 of the cardboard sheet 100 constituting the first inner cushion 12 is the front-rear direction. In other words, the first inner cushion 12 has the inner core 101 whose lateral direction runs along the front-rear direction. In yet other words, in part of the cardboard sheet 100 disposed in the internal space of the first tubular cushion 11 as the first inner cushion 12, the lateral direction of the inner core 101 runs along the front-rear direction.

The first inner cushion 12 is a layered block formed by laying part of the cardboard sheet 100 over itself a plurality of times in the up-down direction. The layered block as the first inner cushion 12 is formed by folding part of the cardboard sheet 100 in a zig zag manner. In other words, the first inner cushion 12 has a plurality of inner cores 101 laid over each other in the up-down direction. For example, the first inner cushion 12 is a layered block formed by laying three cardboard sheets 100 over each other and has three inner cores 101 that overlap each other in the up-down direction.

In the cardboard sheet 100, the part that constitutes the first inner cushion 12 is disposed substantially parallel to the third and fourth wall portions 113 and 114 and is disposed between the third and fourth wall portions 113 and 114 in the up-down direction. In other words, the inner core 101 of the first inner cushion 12 is disposed between the third and fourth wall portions 113 and 114. The top surface of the topmost layer of the first inner cushion 12 may or may not be in contact with the inner surface of the third wall portion 113 (the inner surface is, in other words, the top surface). Furthermore, the bottom surface of the bottommost layer of the first inner cushion 12 may or may not be in contact with the inner surface of the fourth wall portion 114 (the inner surface is, in other words, the bottom surface). For example, the first inner cushion 12 makes contact with the inner surface of the fourth wall portion 114 and is disposed so as to keep a distance from the inner surface of the third wall portion 113 in the up-down direction.

The first inner cushion 12 is disposed so as to keep a distance from the inner surface of the first wall portion 111 in the front-rear direction. In other words, a gap G (space) is left between an end part of the first inner cushion 12 at the front side and the inner surface of the first wall portion 111. In yet other words, the inner core 101 of the first inner cushion 12 is disposed so as to keep a distance from the inner surface of the first wall portion 111 in the front-rear direction. When a plurality of inner cores 101 that constitute the first inner cushion 12 are laid on each other in the up-down direction, all the inner cores 101 that constitute the first inner cushion 12 are disposed so as to keep a distance from the inner surface of the first wall portion 111 in the front-rear direction.

In the embodiment, with the structure described above, it is possible to obtain the first cushion member 110 that can exert a damping effect continuously with respect to a plurality of times of impacts.

Specifically, when a first impact is applied from in front of the first tubular cushion 11, the third and fourth wall portions 113 and 114 each crush in the front-rear direction, so that the first impact from in front is damped. In other words, the first tubular cushion 11 deforms to damp the first impact applied from in front. With the first impact applied to them, the third and fourth wall portions 113 and 114 may buckle.

Since the first inner cushion 12 is disposed so as to keep a distance from the inner surface of the first wall portion 111 in the front-rear direction, when the first impact is applied, the first inner cushion 12 does not function as a shock absorber. That it, the first inner cushion 12 does not deform (does not crush). For example, when an impact from in front is applied to the first tubular cushion 11 once or more, the first wall portion 111 makes contact with the first inner cushion 12. Thus, once the first tubular cushion 11 has crushed in the front-rear direction, the first inner cushion 12 can thereafter exert a damping effect.

After the first impact, the first inner cushion 12 damps a second impact further applied from in front. Specifically, when, after the first impact is applied once or more, the first wall portion 111 makes contact with the first inner cushion 12, that is, once the first tubular cushion 11 has deformed, if the second impact is applied from in front with the first tubular cushion 11 deformed, the first inner cushion 12 deforms to damp the second impact.

Here, the direction of the impact applied to the first inner cushion 12 substantially coincides with the lateral direction of the inner core 101 that constitutes the first inner cushion 12. That is, the impact is applied to the first inner cushion 12 in such a way as to crush the inner core 101 in the lateral direction. When such an impact is applied to the first inner cushion 12, the inner core 101 that constitutes the first inner cushion 12 deforms so as to shrink in the front-rear direction (lateral direction), but if the inner core 101 has not crushed completely in the front-rear direction, the first inner cushion 12 can continue to exert a damping effect. As a result, the first cushion member 110 can continuously exert a damping effect against a plurality of times of impacts.

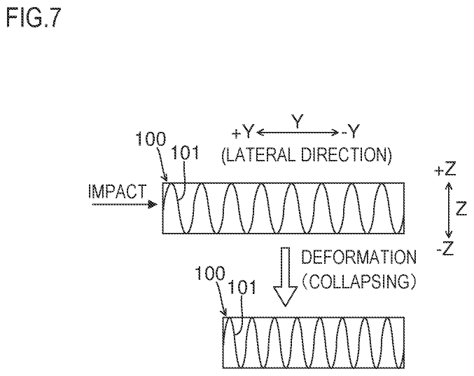

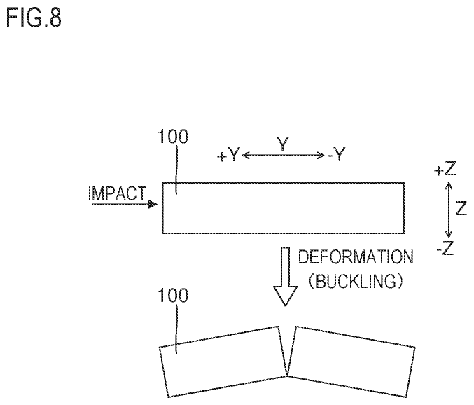

However, if the first inner cushion 12 has deformed into an unintended form, the first inner cushion 12 stops functioning as a shock absorber. Specifically, when the first inner cushion 12 crushes (collapses) in the front-rear direction, that is, when the first inner cushion 12 deforms as shown in FIG. 7, the first inner cushion 12 still continues to exert a damping effect. On the other hand, if the first inner cushion 12 folds (buckles), that is, if the first inner cushion 12 deforms as shown in FIG. 8, the first inner cushion 12 thereafter exerts a diminished damping effect. Thus, the first inner cushion 12 may stop functioning as a shock absorber.

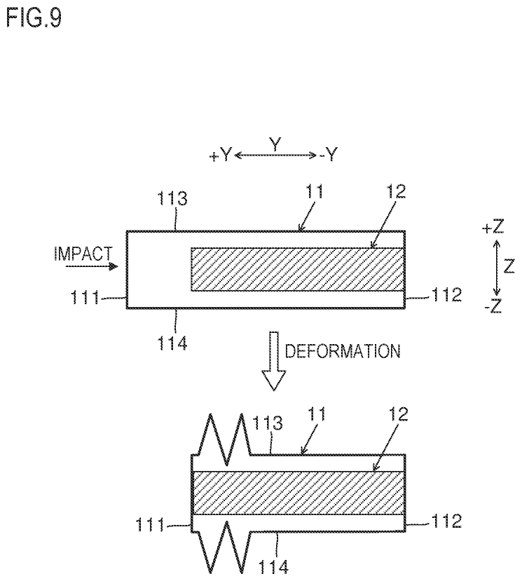

Here, the first tubular cushion 11 is deformed by the first impact, but how it deforms (folds) varies. For example, the first tubular cushion 11 can fold in two inward or outward of the tube. In some cases, the first tubular cushion 11 may deform from the shape in the upper diagram in FIG. 9 to the shape in the lower diagram. Here, FIG. 9 is a schematic diagram. In FIG. 9, the first tubular cushion 11 is indicated by thick lines, and the first inner cushion 12 is indicated by a hatched rectangular area. In FIG. 9, the upper diagram shows a state of the first tubular cushion 11 immediately before the first impact is applied, and the lower diagram shows a state of the first tubular cushion 11 after the first impact has been applied.

As shown in FIG. 9, with the first impact applied to it, the first tubular cushion 11 may fold mainly in a part of it at the front side. When the first tubular cushion 11 deforms into such a shape, a state where the first inner cushion 12 is held between the third and fourth wall portions 113 and 114 is maintained.

Thus, when the second impact is applied, the first tubular cushion 11, in its internal space, makes contact with the surface of the liner 102 that is bonded to the inner core 101 in the first inner cushion 12 and thereby restricts deformation of the first inner cushion 12 in directions other than the front-rear direction. In other words, when the second impact is applied, even if the first inner cushion 12 tends to deform in such a direction that the first inner cushion 12 folds upward (or downward), due to the presence of the third and fourth wall portions 113 and 114 at the top and bottom sides of the first inner cushion 12 respectively, deformation of the first inner cushion 12 upward or downward is restricted.

When the second impact is applied, deformation of the first inner cushion 12 in directions other than the front-rear direction is restricted, and thus it is possible to deform (collapse) the first inner cushion 12 in the front-rear direction. In this way, when, after the second impact is applied, an impact is applied again from in front, the first inner cushion 12 can exert a damping effect.

Hereinafter, with reference to FIG. 10, a description will be given of how the first cushion member 110 is formed (how the cardboard sheet 100 is folded). In FIG. 10, thick solid lines are cutting lines, broken lines are valley fold lines, and dash-dot lines are mountain fold lines. In FIG. 10, the cutting lines, the valley fold lines, and the mountain fold lines are only shown in a part (the part enclosed by a dash-dot-dot line) corresponding to the first tubular cushion 11 and the first inner cushion 12.

The first cushion member 110 is formed by folding the cardboard sheet 100 (1001) shown in FIG. 10. Specifically, first, of the cardboard sheet 1001, the part to become the first inner cushion 12 is folded. Then, the part to become the first tubular cushion 11 is folded into a hollow rectangular columnar shape so as to enclose the first inner cushion 12. In FIG. 10, the lateral direction of the cardboard sheet 1001 (inner core 101) is a D1 direction.

With the structure of the embodiment, by folding a single cardboard sheet 1001, it is possible to easily form the first cushion member 110 including the first tubular cushion 11 and the first inner cushion 12. That is, simply by folding the cardboard sheet 1001 along the folding lines, it is possible to align the lateral direction of the inner core 101 constituting the first inner cushion 12 with the front-rear direction.

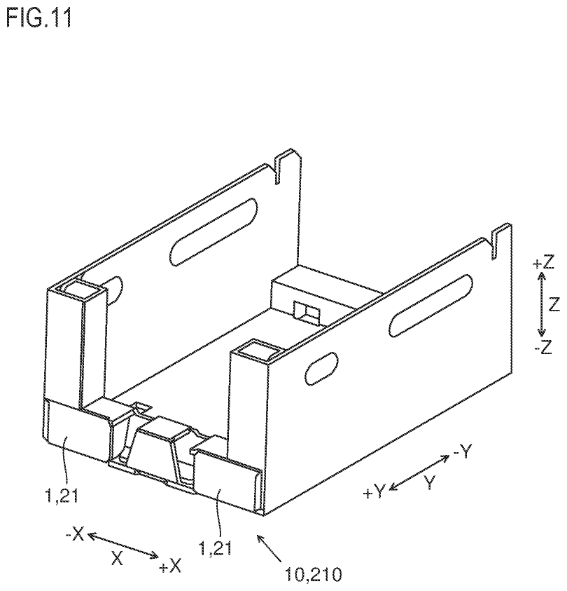

Next, with reference to FIGS. 11 to 14, a description will be given of the second tubular cushion 21 and the second inner cushion 22.

The second tubular cushion 21 is in a tubular form having a tubular axis that runs along the left-right direction. The second tubular cushion 21 is folded into a hollow rectangular columnar shape. When the second cushion member 210 is accommodated in the packing case 2000 together with the article to be packed 1000, one of the four surfaces of the outer wall of the second tubular cushion 21 faces the article to be packed 1000 and makes contact with the front bottom side of the article to be packed 1000.

Specifically, the second tubular cushion 21 has a first wall portion 211 and a second wall portion 212 that are disposed so as to face each other in the front-rear direction. The second tubular cushion 21 also has a third wall portion 213 and a fourth wall portion 214 that are disposed so as to face each other in the up-down direction.

The first wall portion 211 is disposed at the front side. The second wall portion 212 is disposed at the rear side. The second wall portion 212 faces the article to be packed 1000 in the front-rear direction and makes contact with the article to be packed 1000 from in front. In other words, the outer surface of the second wall portion 212 makes contact with the article to be packed 1000. The third wall portion 213 is disposed at the top side and the fourth wall portion 214 is disposed at the bottom side.

The second inner cushion 22 is disposed in the internal space of the second tubular cushion 21. Specifically, the second inner cushion 22 is disposed in a space surrounded by the first, second, third, and fourth wall portions 211, 212, 213 and 214. In other words, the second tubular cushion 21 has the second inner cushion 22 in its internal space. In yet other words, the second tubular cushion 21 has the inner core 101 in its internal space.

The second inner cushion 22 is disposed such that the lateral direction of the inner core 101 of the second inner cushion 22 runs along the front-rear direction. The lateral direction of the inner core 101 of the cardboard sheet 100 constituting the second inner cushion 22 is the front-rear direction. In other words, the second inner cushion 22 has the inner core 101 whose lateral direction runs along the front-rear direction. In yet other words, in part of the cardboard sheet 100 disposed in the internal space of the second tubular cushion 21 as the second inner cushion 22, the lateral direction runs along the front-rear direction.

The second inner cushion 22 is disposed so as to keep a distance from the inner surface of the second wall portion 212 in the front-rear direction. In other words, a gap G (space) is left between an end part of the second inner cushion 22 at the rear side and the inner surface of the second wall portion 212. In yet other words, the inner core 101 of the second inner cushion 22 is disposed so as to keep a distance from the inner surface of the second wall portion 212 in the front-rear direction.

Here, the second inner cushion 22 includes a horizontal wall portion 22A whose plate thickness direction is the up-down direction. The second inner cushion 22 further includes a vertical wall portion 22B whose plate thickness direction runs along the left-right direction.

The horizontal wall portion 22A is disposed substantially parallel to the third wall portion 213. The horizontal wall portion 22A may or may not be in contact with the inner surface of the third wall portion 213 (the inner surface is, in other words, the top surface). The vertical wall portion 22B is disposed upright from the inner surface of the fourth wall portion 214 (the inner surface is, in other words, the bottom surface).

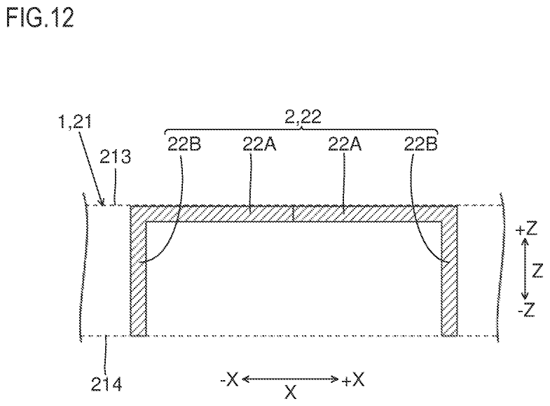

For example, in the internal space of the second tubular cushion 21, two pairs of vertical wall portions 22B are disposed. The horizontal wall portions 22A extend in the left-right direction from top end parts (end parts at the top side) of the vertical wall portions 22B. The horizontal wall portions 22A that extend from one pair of vertical wall portions 22B are connected together (see FIG. 12).

In the embodiment, with the structure described above, it is possible to obtain the second cushion member 210 that can exert a damping effect continuously with respect to a plurality of times of impacts.

Specifically, when a first impact is applied from in front of the second tubular cushion 21, the third and fourth wall portions 213 and 214 each crush in the front-rear direction, so that the first impact from in front is damped. In other words, the second tubular cushion 21 deforms to damp the first impact applied from in front. With the first impact applied to them, the third and fourth wall portions 213 and 214 may buckle.

Since the second inner cushion 22 is disposed so as to keep a distance from the inner surface of the second wall portion 212 in the front-rear direction, when the first impact is applied, the second wall portion 212 does not function as a shock absorber. That it, the second inner cushion 22 does not deform (does not crush). For example, when an impact from in front is applied to the second tubular cushion 21 once or more, the second wall portion 212 makes contact with the second inner cushion 22. Thus, once the second tubular cushion 21 has crushed in the front-rear direction, the second inner cushion 22 can thereafter exert a damping effect.

Specifically, suppose that, after as a result of the first impact being applied once or more the second wall portion 212 has made contact with the second inner cushion 22, that is, the second tubular cushion 21 has deformed, and so with the second tubular cushion 21 deformed, the second impact is applied from in front. In that case, the impact is applied to the second inner cushion 22. Here, the second inner cushion 22 deforms to damp the second impact applied from in front.

Here, the direction of the impact applied to the second inner cushion 22 substantially coincides with the lateral direction of the inner core 101 constituting the second inner cushion 22. That is, the impact is applied to the second inner cushion 22 in such a way as to crush the inner core 101 in the lateral direction. When such an impact is applied to the second inner cushion 22, the inner core 101 that constitutes the second inner cushion 22 deforms so as to shrink in the front-rear direction (lateral direction), but if the inner core 101 has not crushed completely in the front-rear direction, the second inner cushion 22 can continue to exert a damping effect. As a result, the second cushion member 210 can continuously exert a damping effect with respect to a plurality of times of impacts.

Hereinafter, with reference to FIG. 15, a description will be given of how the second cushion member 210 is formed (how the cardboard sheet 100 is folded). In FIG. 15, thick solid lines are cutting lines and broken lines are valley fold lines. In FIG. 15, the cutting lines and the valley fold lines are only shown in a part (the part enclosed by a dash-dot-dot line) corresponding to the second tubular cushion 21 and the second inner cushion 22.

The second cushion member 210 is formed by folding the cardboard sheet 100 (1002) shown in FIG. 15. Specifically, first, of the cardboard sheet 1002, the part to become the second inner cushion 22 is folded. Then, the part to become the second tubular cushion 21 is folded into a hollow rectangular columnar shape so as to enclose the second inner cushion 22. In FIG. 15, the lateral direction of the cardboard sheet 1002 (inner core 101) is a D2 direction.

With the structure of the embodiment, by folding a single cardboard sheet 1002, it is possible to easily form the second cushion member 210 including the second tubular cushion 21 and the second inner cushion 22. That is, simply by folding the cardboard sheet 1002 along the folding lines, it is possible to align the lateral direction of the inner core 101 constituting the second inner cushion 22 with the front-rear direction.

The embodiments disclosed herein should be understood to be in every aspect illustrative and not restrictive. The scope of the present disclosure is not limited by the description of the embodiments given above but by the appended claims, and encompasses any modifications made within a sense and scope equivalent to those of the claims.

What is claimed is:

1. A cushion member formed by folding a single cardboard sheet comprising:
a tubular cushion in a tubular form having a tubular axis extending in a first direction, the tubular cushion disposed adjacent to and in contact with an article to be packed from one side in a second direction perpendicular to the first direction, the tubular cushion deforming to dam a first impact applied from the second direction; and
an inner cushion disposed in an internal space of the tubular cushion, the inner cushion deforming to damp a second impact when, after the first impact, with the tubular cushion deformed, the second impact is applied from the second direction,
wherein
the cardboard sheet has narrow pipes formed by an inner core in a form of a corrugated plate and a pair of liners in a form of flat plates that are bonded to the inner core, and
a longitudinal direction of the narrow pipes of the cardboard sheet is the first direction, and a lateral direction of the narrow pipes perpendicular to the longitudinal direction is the second direction.

2. The cushion member according to claim 1,
wherein
the tubular cushion has a first wall portion and a second wall portion that are disposed so as to face each other in the second direction,
the first wall portion is disposed at one side in the second direction,
the second wall portion is disposed at another side in the second direction,
an outer surface of the second wall portion makes contact with the article to be packed, and
the inner cushion is disposed at a distance in the second direction from an inner surface of at least one of the first and second wall portions.

3. A cushion member according to claim 2,
wherein
the tubular cushion further has a third wall portion and a fourth wall portion that are disposed so as to face each other in an up-down direction,
the third wall portion is disposed at a top side in the up-down direction,
the fourth wall portion is disposed at a bottom side in the up-down direction, and
the inner cushion makes contact with an inner surface of the fourth wall portion and is disposed at a distance from an inner surface of the third wall portion in the up-down direction.

4. The cushion member according to claim 1,
wherein,
when the second impact is applied, in the internal space, the tubular cushion makes contact with a surface of the pair of liners that are bonded to the inner core in the inner cushion to allow the inner cushion to deform only in the second direction.

5. The cushion member according to claim 1,
wherein
the inner cushion is a layered block formed by folding part of the cardboard sheet in a zig zag manner.
